(19) United States
(12) Patent Application Publication
(10) Pub. No.: US 2012/0225921 A1
(43) Pub. Date: Sep. 6, 2012

(54) METHOD OF CONTROLLING PHYTOPATHOGENIC DISEASES ON TURFGRASS

(75) Inventors: Dietrich Hermann, Basel (CH); Jose Otilio Milan, Greensboro, NC (US); Colin Edward Mills, Basel (CH); Mark Zajac, Greensboro, NC (US)

(73) Assignee: SYNGENTA CROP PROTECTION, LLC, Greensboro, NC (US)

(21) Appl. No.: 13/468,013

(22) Filed: May 9, 2012

Related U.S. Application Data
(63) Continuation of application No. 12/295,309, filed on Nov. 18, 2008, now abandoned.

(30) Foreign Application Priority Data
Apr. 7, 2006 (EP) 06007388.9
Apr. 10, 2006 (EP) 06007481.2

(51) Int. Cl. A01N 43/56; A01P 3/00

(52) U.S. Cl. 514/406

(57) ABSTRACT

A method of controlling phytopathogenic diseases on turfgrass or on seeds thereof, which comprises applying to the turfgrass, the locus thereof or seeds thereof a composition, that, in addition to formulation adjuvants, comprises a fungicidally effective amount of at least one compound of formula I

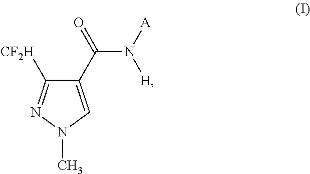

wherein A is

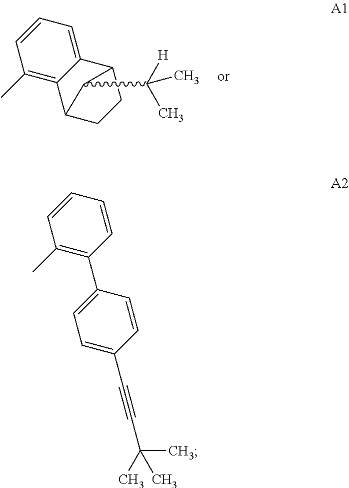

or a tautomer of such a compound.

This application is a continuation of copending U.S. application Ser. No. 12/295309, filed on 3 Apr. 2007, herein incorporated by reference in its entirety for all purposes

The present invention relates to a method of controlling phytopathogenic diseases on turfgrass.

Methods of controlling phytopathogenic diseases on turfgrass by using substituted thiophene derivates are disclosed in JP-2004-123587. One of said substituted thiophene derivates is the pyrazole carboxamide compound N-[2-(1,3-dimethylbutyl)-3-thienyl]-1-methyl-3-(trifluoromethyl)-1H-pyrazole-4-carboxamide also known as Penthiopyrad.

From WO 04/035589 and WO 04/058723 it is known that certain heterocyclo-carboxamides have biological activity against phytopathogenic fungi. WO 04/035589 and WO 04/058723 disclose the use of said heterocyclo-carboxamides to control or prevent diseases in crop plants, such as wheat, apple, barley, grape, tomato and rice. The use of said heterocyclo-carboxamides to control diseases on turfgrass is not mentioned in WO 04/035589 or WO 04/058723.

High quality, healthy turf is essential, for example, to the golfing industry. Accordingly, there remains a need in the art for novel methods to enhance turfgrass quality and protect turfgrass against phytopathogenic diseases to provide high quality, healthy turf.

Suprisingly it was found that a pyrazole carboxamide selected from 3-Difluoromethyl-1-methyl-1H-pyrazole-4-carboxylic acid (9-isopropyp-1,2,3,4-tetrahaydro-1,4-methano-naphthalen-5-yl)-amide (IA) and 3-Difluoromethyl-1-methyl-1H-pyrazole-4-carboxylic acid [4′-(3,3-dimethyl-but-1-ynyl)-biphenyl-2-yl]-amide (IB) is suitable for controlling phytopathogenic diseases on turfgrass.

According to the present invention, there is provided a method of controlling phytopathogenic diseases on turfgrass or on seeds thereof, which comprises applying to the turfgrass, the locus thereof or seeds thereof a composition, that, in addition to formulation adjuvants, comprises a fungicidally effective amount of at least one compound of formula I

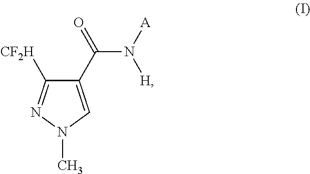

wherein A is

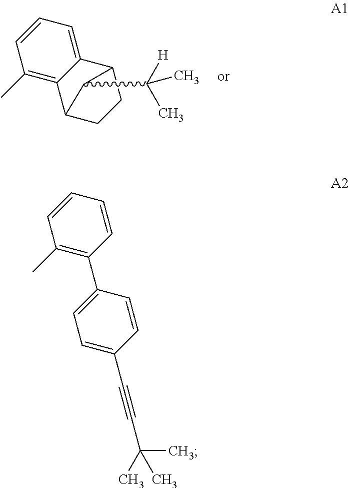

or a tautomer of such a compound.

The method according to the invention is especially suitable to improve the quality of turfgrass. Therefore another aspect of the present invention is a method to improve the quality of turfgrass, which comprises applying to the turfgrass, the locus thereof or seeds thereof a composition, that, in addition to formulation adjuvants, comprises an amount effective to increase turfgrass quality of a compound of formula I

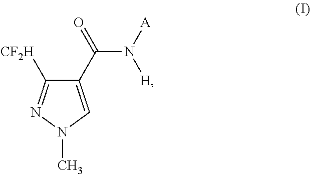

wherein A is

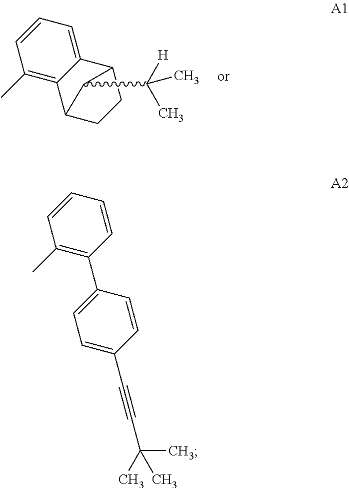

or a tautomer of such a compound.

As used herein the phrase “quality” of turfgrass is meant to include visual quality of turfgrass and functional quality of turfgrass.

“Visual quality” of turfgrass relates to the visual appearance, such as density (the number of aerial shoots per unit area), uniformity (for example uniformity of texture, e.g. width of the leaf blades, which can be fine-textured as for example in red fescue or coarse-textured as for example in tall fescue), colour or smoothness (which affects for example the playability of a golf course).

“Functional quality” of turfgrass relates to, for example, rigidity (resistance of the turfgrass leaves to compression and is related to the wear resistance of a turf), elasticity (tendency of the turfgrass leaves to spring back once a compressing force is removed), resiliency (capacity of a turf to absorb a shock without altering its surface characteristics), ball roll (average distance a ball travels upon being released to a turf surface), yield (measure of clippings removed with mowing), verdure (measure of amount of aerial shoots remaining after mowing), rooting (amount of root growth evident at any one time during the growing season) and recuperative capacity (capacity of turfgrasses to recover from damage caused by disease organism, insects, traffic and the like).

An improvement in the quality of turfgrass can relate to one of the mentioned visual or functional quality characteristics or to any combination of these quality characteristics.

According to the present invention, an “improvement” is a measurable or noticeable increase in a given turfgrass quality characteristic over the same turfgrass quality characteristic produced under the same conditions, but without the application of the subject method.

An improvement in the quality characteristics of turfgrass is, for example, a greener or more pleasant, leaf colour of the turf.

In a preferred embodiment of the present invention, compositions according to the invention comprise compound 3-Difluoromethyl-1-methyl-1H-pyrazole-4-carboxylic acid (9-isopropyp-1,2,3,4-tetrahydro-1,4-methano-naphthalen-5-yl)-amide, of formula IA

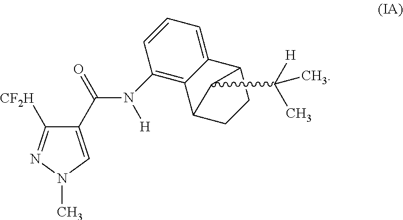

The compounds of formula IA occur in different stereoisomeric forms, which are described as the single enantiomers of formulae IA_{I}, IA_{II}, IA_{III} and IA_{IV}:

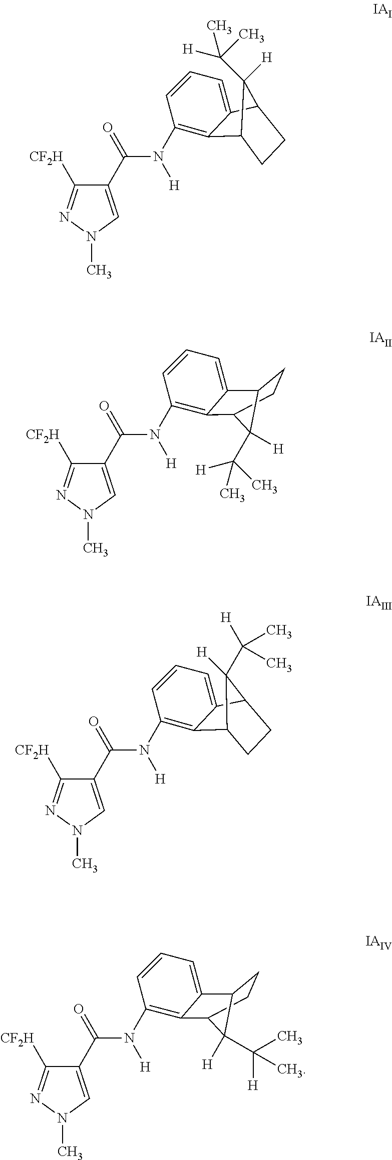

The invention covers all such single enantiomers and mixtures thereof in any ratio.

The compounds of formula IA and their manufacturing processes starting from known and commercially available compounds are described in WO 04/035589.

The compounds of formula IA can be prepared by reacting an acid chloride of formula II

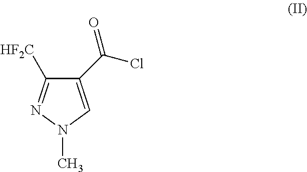

with an amine of formula III

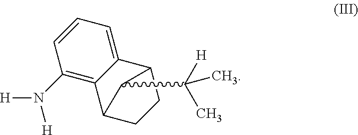

Amines of formula III can be produced, for example, according to schemes 1, 2 or 3.

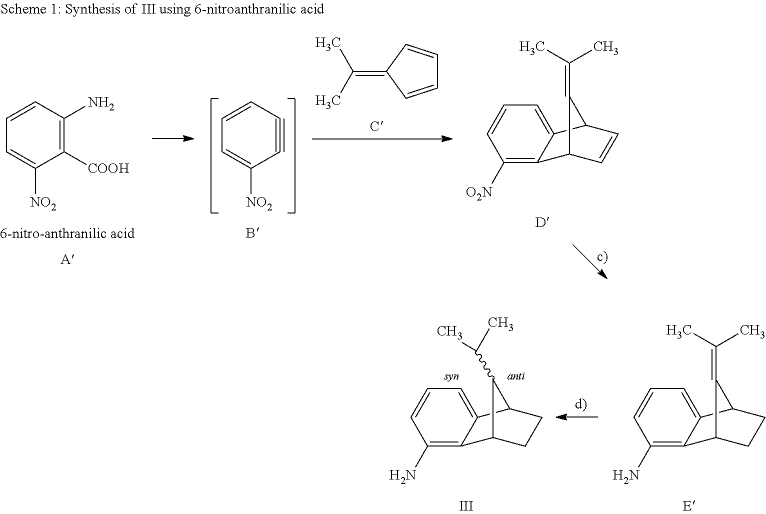

The 9-Alkylidene-5-nitro-benzonorbornadiene of formula D′ can be synthesized through Diels-Alder addition of an in situ generated benzyne B′ [for example starting from a 6-nitroanthranilic acid of formula (A′) by diazotation with i-amyl or t-butyl nitrite], as described by L. Paquette et al, J. Amer. Chem. Soc. 99, 3734 (1977) or from other suitable precursors (see H. Pellissier et al. Tetrahedron, 59, 701 (2003), R. Muneyuki and H. Tanida, J. Org. Chem. 31, 1988 (1966)] to a 6,6-dimethylfulvene according to or by analogy to R. Muneyuki and H. Tanida, J. Org. Chem. 31, 1988 (1966), P. Knochel et al, Angew. Chem. 116, 4464 (2004), J. W. Coe et al, Organic Letters 6, 1589 (2004), L. Paquette et al, J. Amer. Chem. Soc. 99, 3734 (1977), R. N. Warrener et al. Molecules, 6, 353 (2001), R. N. Warrener et al. Molecules, 6, 194 (2001).

Suitable aprotic solvents for this step are for example diethyl ether, butyl methyl ether, ethyl acetate, dichloromethane, acetone, tetrahydrofurane, toluene, 2-butanone or dimethoxyethane. Reaction temperatures range from room temperature to 100° C., preferably 35-80° C.

The 6,6-dimethylfulvene of formula C′ is available according to M. Neuenschwander et al, Helv. Chim. Acta, 54, 1037 (1971), ibid 48, 955 (1965). R. D. Little et al, J. Org. Chem. 49, 1849 (1984), I. Erden et al, J. Org. Chem. 60, 813 (1995) and S. Collins et al, J. Org. Chem. 55, 3395 (1990).

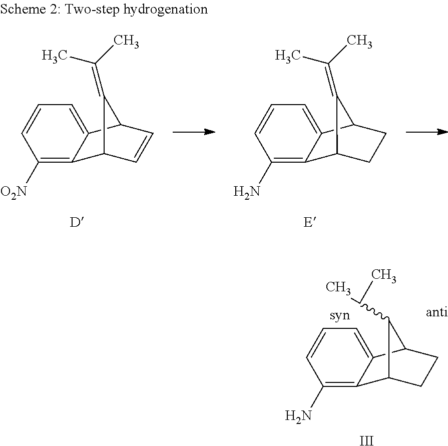

The aniline of formula E′ may be obtained according to scheme 2 by partial hydrogenolysis of D′, for example by interrupting H₂ uptake after 4 equivalents. Suitable solvents include tetrahydrofurane, ethyl acetate, methanol, ethanol, toluene or benzene and others. Catalysts are for example Ra/Ni, Rh/C or Pd/C. Pressure: atmospheric pressure or pressure up to 6 bar, preferentially atmospheric pressure. Temperatures range from room temperature or up to 50° C., preferentially 20-30° C.

The anilines of formula III may be obtained from the aniline of formula E′ by hydrogenation. Suitable solvents are for example tetrahydrofurane, methanol, ethanol, toluene, dichloromethane, ethyl acetate. Preferred solvents are tetrahydrofurane and methanol. Temperatures range from 10 to 50° C., preferentially 20-30° C., more preferred room temperature. Pressure: atmospheric pressure to 150 bar, preferred is atmospheric pressure to 100 bar. The choice of catalyst influences the syn/anti-ratio. Catalysts such as Rh/C, Rh/Al₂O₃, Rh₂O₃, Pt/C or PtO₂ result in syn-enrichment (preferred Rh/C). Catalysts such as Ra/Ni, Ir(COD)Py(Pcy) or Pd/C result in anti-enrichment (preferred Pd/C).

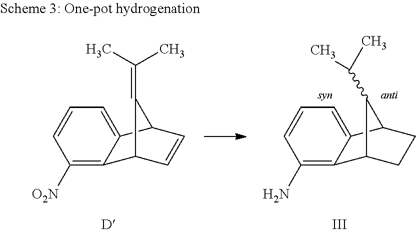

The aniline of formula III may be obtained by a one-pot reaction from the compound of formula D′ via exhaustive hydrogenation (scheme 3). Suitable solvents are for example tetrahydrofurane, methanol, ethanol, toluene or ethyl acetate. Preferred solvents are tetrahydrofurane or methanol. Suitable temperatures range from room temperature to 50° C., preferably from room temperature to 30° C., most preferably room temperature. Suitable pressure ranges from atmospheric pressure to 100 bar, more preferably from atmospheric pressure to 50 bar, even more preferably from atmospheric pressure to 20 bar, most preferably from atmospheric pressure to 4-6 bar. Likewise, as described for scheme 2 above, the choice of catalyst influences the syn/anti-ratio. Catalysts such as Rh/C, Rh/Al₂O₃, Rh₂O₃, Pt/C or PtO₂ result in syn-enrichment. Catalysts such as Pd/C, Ir(COD)Py(Pcy) or Ra/Ni result in anti-enrichment (preferred catalyst is Pd/C).

The following examples illustrate the production of compounds of formula III.

a) Benzyne Adduct

### EXAMPLE H1

### 9-Isopropylidene-5-nitro-benzonorbornadiene

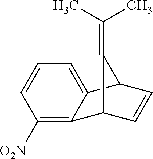

A mixture of 6-nitroanthranilic acid (110.4 g, 0.6 mol) and 6,6-dimethylfulvene (98.5 g, 1.5 eq.) in 700 ml dimethoxyethane was added dropwise to a solution of t-butyl nitrite (96.3 g, 1.4 eq.) in 2 litre 1,2-dimethoxyethane under N₂-atmosphere at 72° C. within 20 minutes. A vigorous formation of gas started immediately and the temperature rose to 79° C. Gas formation ceased after 30 min. After 3 h at reflux temperature the mixture was cooled to room temperature, evaporated and purified on silica gel in hexane-ethyl acetate 95:5 resulting in 76.7 g of 9-isopropylidene-5-nitro-benzonorbornadiene as a yellow solid (m.p. 94-95° C.). ¹H-NMR (CDCl3), ppm: 7.70 (d, 1H), 7.43 (d, 1H), 7.06 (t, 1H), 6.99 (m, 2H), 5.34 (brd s, 1H), 4.47 (brd s, 1H), 1.57 (2 d, 6H). ¹³C-NMR (CDCl₃), ppm: 159.83, 154.30, 147.33, 144.12, 142.89, 141.93, 125.23 (2x), 119.32, 105.68, 50.51, 50.44, 19.05, 18.90.

b) Two-Step Hydrogenation

### EXAMPLE H2

### 9-Isopropylidene-5-amino-benzonorbornene

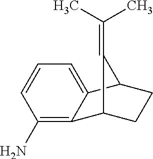

5.0 g 9-isopropylidene-5-nitro-benzonorbornadiene (22 mmol) were hydrogenated in 50 ml tetrahydrofurane in the presence of 1.5 g 5% Rh/C at 25° C. and atmospheric pressure. After uptake of 4 equivalents of hydrogen (2.01 litre or 102% of theory) the mixture was filtered, evaporated and purified on silica gel in hexane-ethyl acetate-6:1 giving 2.76 g 9-isopropylidene-5-amino-benzonorbornene as a solid (m.p. 81-82° C.; yield: 62.9% of theory). ¹H-NMR (CDCl3), ppm: 6.90 (t, 1H), 6.67 (d, 1H), 6.46 (d, 1H), 3.77 (m, 1H), 3.73 (m, 1H), 3.35 (brd, exchangeable with D₂O, 2H), 1.89 (m, 2H), 1.63 (2 s, 6H), 1.26 (m, 2H). ¹³C-NMR (CDCl₃), ppm: 148.73, 147.65, 138.30, 131.75, 126.19, 113.12, 110.89, 110.19, 43.97, 39.44, 26.98, 26.06, 19.85, 19.75.

### EXAMPLE H3

### 9-Isopropyl-5-amino-benzonorbornene

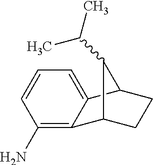

200 mg 9-isopropylidene-5-amino-benzonorbornene were hydrogenated in the presence of 100 mg 5% Rh/C in 40 ml tetrahydrofurane in a stainless steel autoclave at room temperature at 100 bar resulting in 9-isopropyl-5-amino-benzonorbornene in the form of an oil (syn/anti-ratio 9:1). syn-Epimer: ¹H-NMR (CDCl₃), ppm: 6.91 (t, 1H), 6.64 (d, 1H), 6.48 (d, 1H), 3.54 (brd, exchangeable with D₂O, 2H), 3.20 (m, 1H), 3.15 (m, 1H), 1.92 (m, 2H), 1.53 (d, 1H), 1.18 (m, 2H), 1.02 (m, 1H), 0.81 (m, 6H); ¹³C-NMR (CDCl3), ppm: 147.73, 140.03, 130.15, 126.41, 113.35, 112.68, 69.00, 46.62, 42.06, 27.74, 26.83, 25.45, 22.32, 22.04; anti-epimer: ¹H-NMR (CDCl₃), ppm: 6.89 (t, 1H), 6.63 (d, 1H), 6.46 (d, 1H), 3.55 (brd, exchangeable with D₂O, 2H), 3.16 (m, 1H), 3.13 (m, 1H), 1.87 (m, 2H), 1.48 (d, 1H), 1.42 (m, 1H), 1.12 (m, 2H), 0.90 (m, 6H); ¹³C-NMR (CDCl₃), ppm: 150.72, 138.74, 133.63, 126.15, 112.94, 111.53, 68.05, 45.21, 40.61, 26.25, 24.47, 23.55, 20.91 (2×). Assignments were made on the basis of NOE-NMR-experiments.

c) One-Pot Hydrogenation:

### EXAMPLE H4

### 9-Isopropyl-5-amino-benzonorbornene: syn-enrichment

35.9 g 9-isopropylidene-5-nitro-benzonorbornadiene in 400 ml tetrahydrofurane were exhaustively hydrogenated in the presence of 25 g 5% Rh/C over 106 h. Filtration and evaporation of the solvent resulted in 32.15 g 9-isopropyl-5-amino-benzonorbornene in the form of an oil (syn/anti-ratio 9:1; yield: 97.4% of theory). NMR data: see above.

### EXAMPLE H5

### 9-Isopropyl-5-amino-benzonorbornene: anti-enrichment

41.41 g 9-isopropylidene-5-nitro-benzonorbornadiene in 1 litre tetrahydrofurane were exhaustively hydrogenated for four hours in the presence of 22 g 5% Pd/C at room temperature and atmospheric pressure. Filtration and evaporatation followed by purification on silica gel in hexane-ethyl acetate-7:1 gave 29.91 g 9-isopropyl-5-amino-benzonorbornene (syn/anti-ratio 3:7; yield: 81.5%) in the form of an oil. NMR data: see above.

In a preferred embodiment of the present invention, compositions according to the invention comprise a compound of formula IAa (syn)

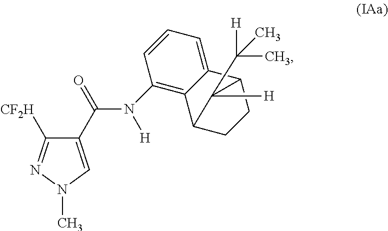

which represents a single enantiomer of formula IA_{I}, a single enantiomer of formula IA_{II} or a mixture in any ratio of the single enantiomers of formulae IA_{I} and IA_{II}.

Preference is given to those compositions according to the invention which comprise a racemic compound of the formula IAa (syn), which represents a racemic mixture of the single enantiomers of formulae IA_{I} and IA_{II}.

In a further preferred embodiment of the present invention, compositions according to the invention comprise a compound of formula IAb (anti)

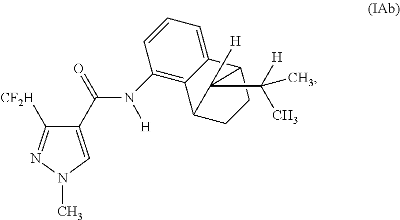

which represents a single enantiomer of formula IA_{III}, a single enantiomer of formula IA_{IV} or a mixture in any ratio of the single enantiomers of formulae IA_{III} and IA_{IV}.

In a further preferred embodiment of the present invention, compositions according to the invention comprise a racemic compound of the formula IAb (anti), which represents a racemic mixture of the single enantiomers of formulae IA_{III} and IA_{IV}.

In a further preferred embodiment of the present invention, compositions according to the invention comprise a compound of formula IAc

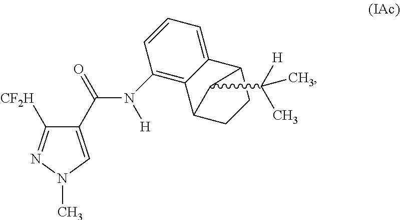

which represents an epimeric mixture of the racemic compounds of formula IAa (syn) and IAb (anti), wherein the ratio of the racemic compound of formula IAa (syn), which represents a racemic mixture of the single enantiomers of formulae IA_{I} and IA_{II}, to the racemic compound of formula IAb (anti), which represents a racemic mixture of the single enantiomers of formulae IA_{III} and IA_{IV}, is from 1000:1 to 1:1000.

In a further preferred embodiment of the present invention, compositions according to the invention comprise a compound of formula IAc, which represents an epimeric mixture of the racemic compounds of formula IAa (syn) and IAb (anti), wherein the content of the racemic compound of formula IAa (syn), which represents a racemic mixture of the single enantiomers of formulae IA_{I} and IA_{II}, is from 70 to 99% by weight, preferrably 85 to 95% by weight.

In a further preferred embodiment of the present invention, compositions according to the invention comprise a compound of formula IAc, which represents an epimeric mixture of the racemic compounds of formula IAa (syn) and IAb (anti), wherein the content of the racemic compound of formula IAb (anti), which represent a racemic mixture of the single enantiomers of formulae IA_{III} and IA_{IV}, is from 60 to 99% by weight, preferrably 64 to 70% by weight.

According to the instant invention, a “racemic mixture” of two enantiomers or a “racemic compound” means a mixture of two enantiomers in a ratio of substantially 50:50 of the two enantiomers.

In a further preferred embodiment of the present invention, compositions according to the invention comprise a compound of formula IB

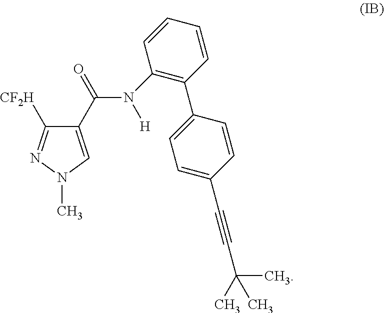

According to the invention, by “turfgrass” there is understood an annual or perennial Gramineae. Said gramineae preferably belongs to one or more of the genera Agropyron, Agrostis, Axonopus, Bromus, Buchloë, Cynodon, Eremochloa, Festuca, Lolium, Paspulum, Pennisetum, Phleum, Poa, Stenotaphrum or Zoysia. More preferably, said gramineae belongs to one or more of the genera Agrostis, Buchloë, Cynodon, Eremochloa, Festuca, Lolium, Paspulum, Pennisetum, Poa, Stenotaphrum or Zoysia.

According to the invention by “turf” is understood as a group of turfgrass, which covers a surface area of ground and is subject to regular maintenance.

The present invention can be practiced with all turfgrasses, including cool season turfgrass and warm season turfgrass.

Examples of cool season turfgrasses are: Bluegrasses (Poa L.), such as Kentucky Bluegrass (Poa pratensis L.), Rough Bluegrass (Poa trivialis L.), Canada Bluegrass (Poa compressa L.) and Annual Bluegrass (Poa annua L.); Bentgrasses (Agrostis L.), such as Creeping Bentgrass (Agrostis palustris Huds.), Colonial Bentgrass (Agrostis tenius Sibth.), Velvet Bentgrass (Agrostis canina L.) and Redtop (Agrostis alba L.); Fescues (Festuca L.), such as Creeping Red Fescue (Festuca rubra L.), Chewings Fescue (Festuca rubra var. commutata Gaud.), Sheep Fescue (Festuca ovina L.), Hard Fescue (Festuca longifolia), Tall Fescue (Festuca arundinacea Schreb.), Meadow Fescue (Festuca elatior L.); Ryegrasses (Lolium L.), such as Perennial Ryegrass (Lolium perenne L.), Annual (Italian) Ryegrass (Lolium multiflorum Lam.); Wheatgrasses (Agropyron Gaertn.), such as Fairway Wheatgrass (Agropyron cristatum (L.) Gaertn.), Western Wheatgrass (Agropyron smithii Rydb.). Other cool season turfgrasses include Smooth Brome (Bromus inermis Leyss.) and Timothy (Phleum L.).

Examples of warm season turfgrasses are Bermudagrasses (Cynodon L. C. Rich), Zoysiagrasses (Zoysia Willd.), St. Augustinegrass (Stenotaphrum secundatum (Walt.) Kuntze), Centipedegrass (Eremochloa ophiuroides (Munro.) Hack.), Carpetgrass (Axonopus Beauv.), Bahiagrass (Paspalum notatum Flugge.), Kikuyugrass (Pennisetum clandestinum Hochst. ex Chiov.), Buffalograss (Buchloe dactyloides (Nutt.) Engelm.) and Seashore paspalum (Paspalum vaginatum swartz).

The method according to the present invention is effective to protect turfgrass or seeds thereof against phytopathogenic fungi.

The method according to the invention is effective to protect turfgrass against Ascochyta Leaf Blight, Brown Stripe, Cephalosporium Stripe, Cercospora Leaf Spot, Cladosporium Eyespot, Copper Spot (Zonate Leaf Spot), Dollar Spot, Gray Leaf Spot, Leaf Blotch (Scald), Leaf Smut, Leptoshaerulina Leaf Blight, Mastigosporium Leaf Spot, Phyllosticta Leaf Blight, Physoderma Leaf Spot, Physoderma Leaf Streak, Pink Patch Leaf Bight, Cream Leaf Bight, Powdery Mildew, Pseudoseptoria Leaf Spot, Red Thread, Rust, Septoria Leaf Spot, Stagnospora Leaf Spot, Snow Mold, Coprinus Snow Mold, Microdochium Patch, Snow Scald, Typhula Blight, Spermospora Leaf Spot, Tar Sport, Yellow Tuft (Downy Mildew), Anthracnose, Bipolaris Disease, Exseohilum Disease, Curvularia Disease, Drechslera Disease, Marielliottia Disease, Fusarium Disease, Nigrospora Blight, Pythium Disease, Rhizoctonia Disease, Seedling Disease, Southern Blight, Dead Spot, Necrotic Ring Spot, Root Decline of Warm-Season Turfgrasses, Spring Dead Spot, Summer Patch, Brown Patch or Take-all Patch. Said diseases and the relating pathogens are described in “Compendium of Turfgrass Diseases” (by R. W. Smiley, P. H. Dernoeden and B. B. Clarke, third edition, American Phytopathological Society Press).

The method according to the invention is particularly effective to protect turfgrass against Colletotrichum graminicola, Pythium spp., Rhizoctonia solani, Sclerotinia homeocarpa, Gaeumannomyces graminis, Microdochium nivale, Typhula incarnate, Pyricularia grisea Drechslera spp., Marielliottia spp., Bipolaris spp., Curvularia spp. or Exserohilum spp.

The method according to the invention is particularly effective to protect turfgrass against Sclerotinia homeocarpa, Rhizoctonia solani or Colletotrichum graminicola.

The method according to the invention is particularly effective to protect turfgrass against Sclerotinia homeocarpa.

The method according to the invention is particularly effective to protect turfgrass against Rhizoctonia solani.

The method according to the invention is particularly effective to protect turfgrass against Colletotrichum graminicola.

The term “locus” of turfgrass as used herein is intended to embrace the place on which the turfgrass are growing, the place where the seeds of the turfgrass are sown or the place where the seeds of the turfgrass will be placed for subsequent plant growth. According to the invention, the “locus” of a turf can relate to soil or to a substrate. An example for such a locus is a golf course, on which turfgrass is managed.

According to the invention the term “soil” means natural soil, which is typically present on a land area, such as soil being present on a golf course, or means soil, that has been modified, such as soil being granulated and/or treated with agrochemicals, such as for example fertilizers. An example of granulated and/or treated soil is disclosed in U.S. Pat. No. 5,265,372.

According to the invention the term “substrate” means a medium for the growth of turfgrass and the like, suited for application to a variety of existing ground structures. Typically, such mediums are soil-free mixtures that include sufficient proportions of ingredients of elastomeric granules, suitable binding emulsion, mineral aggregate, filler and controlled release plant nutrient particles, so that when laid and cured, said mixture produces a water permeable, resilent substrate having air pockets through which a root system of turfgrass can penetrate. Turfgrass growing on said substrate can form a turf, which can be applied to non-porous surfaces, such as for example roofs of buildings, terraces and other hard surface areas, or to porous surfaces, such as for example football fields or golf courses. Examples of such substrates are described in WO 2005/002323. Elastomeric granules can be, for example, granules of rubber, granules of recycled vehicle tyre rubber or mixtures thereof.

The compositions according to the invention are applied to the turfgrass or seed thereof by treating the turfgrass, the locus thereof or seeds thereof with a composition according to the invention.

The amount of a composition according to the invention to be applied will depend on various factors, such as the subject of the treatment, such as, plants, locus or seeds; the type of treatment, such as, for example spraying, spreading or seed dressing; the purpose of the treatment, such as, for example preventive or curative; the type of fungi to be controlled; the application time; environmental conditions or turfgrass species.

In one embodiment of the invention, the compositions according to the invention are applied to the turfgrass by treating the turfgrass or the locus thereof with a composition according to the invention.

In another embodiment of the invention, the compositions according to the invention are applied to the turfgrass by treating the turfgrass with a composition according to the invention.

In yet another embodiment of the invention, the compositions according to the invention are applied to the turfgrass by treating the locus thereof with a composition according to the invention.

In yet another embodiment of the invention, the compositions according to the invention are applied to the seed of the turfgrass by treating the seeds with a composition according to the invention.

Application to Turfgrass:

The compositions according to the invention can be applied to the turfgrass by treating the turfgrass with a composition according to the invention. Within said embodiment of the invention, the compositions according to the invention are preferably applied to the turfgrass by spraying or spreading. Treatment of turfgrass may be performed by lawn care operators.

To maintain high quality, healthy turfgrass on the intended surface area of ground, such as for example, a golf course, a sports field, a park area or a home lawn, and to protect said turfgrass against phytopathogenic diseases, the compositions according to the invention are applied to the turfgrass once or more than once during maintenance of the turfgrass.

Preferably, the compositions according to the invention are applied to the turfgrass once or more than once during a growing season of the turfgrass.

With the composition according to the invention it is possible to inhibit or destroy the pathogens which occur on turfgrass, while at the same time the parts of turfgrass which grow later are also protected from attack by pathogens.

The composition according to the invention may be applied before (“preventive treatment”) or after infection (“curative treatment”) of the turfgrass by the fungi.

When applied to the turfgrass, the compound of formula I is typically applied at a rate of 10 to 2000 g/ha, preferably 100 to 1000 g/ha, more preferably 200 to 800 g/ha, most preferably 250 to 600 g/ha.

Application to the Locus of the Turfgrass:
‘Application of the Locus’ covers liquid (sprayable) or granular (ai on inert and ai on fertilizer (spreadable) applications as well?

The compositions according to the invention can be applied to the turfgrass by treating the locus of the turfgrass with a composition according to the invention.

For example, the compostions according to the invention can be applied to the soil before or after the seeds of the turfgrass are sown or placed into the soil;

or the compositions according to the invention can be applied to a substrate for the growth of turfgrass before or after the seeds of the turfgrass are placed into the substrate;

or the compostions according to the invention can be applied to the soil before turfgrass grown on a substrate are placed on top of the soil together with the substrate.

In one embodiment, the compositions are applied to the turfgrass as a sprayable liquid formulation. In another embodiment, the compositions are applied to the turfgrass as a granular formulation. Suitable granules include inert and fertilizer granules. The active ingredient may be dispersed throughout, impregnated into, or coated on the surface of the granules.

Application to the Seeds of the Turfgrass:

The compositions according to the invention can be applied to the seeds of the turfgrass by treating the seeds with a composition according to the invention.

When the compositions according to the invention are used for treating seed, rates of 0.001 to 50 g of the compound of formula I per kg of seed, preferably from 0.01 to 10 g per kg of seed, are generally sufficient.

The composition of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Said compositions according to the invention may be produced in conventional manner, e.g. by mixing the compound of formula I with at least one appropriate formulation adjuvant.

The term “formulation adjuvant” according to the invention denotes a natural or synthetic, organic or inorganic material with which the compound of formula I is combined in order to facilitate its application to turf. This adjuvant is hence generally inert, and it must be agriculturally acceptable, in particular to turf.

The formulation adjuvant can be a carrier or a surfactant. In compositions according to the invention more than one adjuvant can be present, in such embodiments more than one carrier and/or more than one surfactant can be present, a non-limiting example would be one carrier and two surfactans.

The “carrier” can be a liquid carrier (water, alcohols, ketones, petroleum fractions, aromatic or paraffinic hydrocarbons, chlorinated hydrocarbons, liquefied gases, and the like) or a solid carrier.

Suitable liquid carriers are, but are not restricted to: aromatic hydrocarbons, in particular the fractions C₈ to C₁₂, such as xylene mixtures or substituted naphthalenes, phthalic esters such as dibutyl or dioctyl phthalate, dipropylene glycol dibenzoate, aliphatic hydrocarbons such as cyclohexane or paraffins, alcohols and glycols as well as their ethers, esters and diesters, such as ethylene glycol monomethyl ether, ketones such as cyclohexanone, strongly polar solvents such as, but not restricted to, N-methyl-2-pyrrolidone, dimethyl sulfoxide or dimethylformamide, and, if appropriate, epoxidized vegetable oils or soybean oil; or water.

Suitable solid carriers are, but are not restricted to: aluminium silicate, urea, sodium sulphate, talc, calcium sulphate or potassium sulphate.

According to the invention a single carrier or a mixture of two or more carriers may be present in the composition according to the invention.

“Surfactants” are non-ionic, cationic, amphoteric and/or anionic surfactants having good emulsifying, dispersing and wetting properties. According to the invention a single surfactant or a mixture of two or more surfactants may be present. The surfactants customarily employed in formulation technology are described, inter alia, in the following publications: “McCutcheon's Detergents and Emulsifiers Annual”, MC Publishing Corp., Glen Rock, N.J., 1988 and M. and J. Ash, “Encyclopedia of Surfactants”, Vol. I-III, Chemical Publishing Co., New York, 1980-1981.

Among the surfactants there may be mentioned, e.g., polyacrylic acid salts, lignosulphonic acid salts, phenolsulphonic or (mono- or di-alkyl)naphthalenesulphonic acid salts, laurylsulfate salts, polycondensates of ethylene oxide with lignosulphonic acid salts, polycondensates of ethylene oxide with fatty alcohols or with fatty acids or with fatty amines, substituted phenols (in particular alkylphenols or arylphenols such as mono- and di-(polyoxyalkylene alkylphenol)phosphates, polyoxyalkylene alkylphenol carboxylates or polyoxyalkylene alkylphenol sulfates), salts of sulphosuccinic acid esters, taurine derivatives (in particular alkyltaurides), polycondensates of ethylene oxide with phosphated tristyrylphenols and polycondensates of ethylene oxide with phosphoric esters of alcohols or phenols.

A seed dressing formulation is applied in a manner known per se to the seeds employing the compositions according to the invention and a diluent in suitable seed dressing formulation form, e.g. as an aqueous suspension or in a dry powder form having good adherence to the seeds. Such seed dressing formulations are known in the art. Seed dressing formulations may contain the active ingredients in encapsulated form, e.g. as controlled release capsules or microcapsules.

The compositions according to the invention may comprise one or more formulation additives, such as, but not limited to, biocides, anti-freeze, stickers, thickeners and compounds that provide adjuvancy effects.

The compositions according to the invention may comprise one or more additional active ingredient, such as a fungicide, insecticide, herbicide or growth regulator. An example would be a composition that comprise another fungicide. Any suitable fungicide or herbicide may be used in the composition, for example to provide control of a broader spectrum of pests, to overcome problems and delay the onset of resistance, or to provide improved efficacy though an additive or synergistic effect of the active ingredients.

In one embodiment, the compositions of the invention comprise one or more additional active ingredients selected from the list comprising azoxystrobin, propiconazole, chlorathalonil, difenoconazole, fludioxonil, mefenoxam, cyprodinil, thiophanate methyl, iprodione, triadimefon, propamocarb, fosetyl-al, flutalonil, pyraclostrobin, boscalid, vinclozolin, trifloxystrobin, myclobutanil, fenarimol, phosphites and fluoxastrobin. Preferably, the compostions of the invention comprise azoxystrobin, propiconazole or chlorathalonil.

In one embodiment of the invention, the compositions according to the invention do not comprise an additional active ingredient. This embodiment provides a method of controlling phytopathogenic diseases on turfgrass or on seeds thereof, which comprises applying to the turfgrass, the locus thereof or seeds thereof a composition, that, in addition to formulation adjuvants, comprises an active ingredient, which consists essentially of a fungicidally effective amount of a compound of formula I or a tautomer of such a compound.

In a further embodiment there is provided a method of controlling phytopathogenic diseases on turfgrass or on seeds thereof, which comprises applying to the turfgrass, the locus thereof or seeds thereof a composition, that, in addition to formulation adjuvants, comprises an active ingredient, which consists of a fungicidally effective amount of a compound of formula I or a tautomer of such a compound.

In general, the compositions according to the invention include from 0.01 to 90% by weight of a compound of formula I, from 0 to 20% surfactant and from 10 to 99.99% carrier.

Concentrated forms of compositions according to the invention generally contain in between about 2 and 80%, preferably between about 5 and 70% by weight of a a compound of formula I. Application forms of formulation may for example contain from 0.01 to 20% by weight, preferably from 0.01 to 5% by weight of a compound of formula I. Whereas commercial products will preferably be formulated as concentrates, the end user will normally employ diluted formulations.

The Examples which follow serve to illustrate the invention, “active ingredient” denoting a compound of formula I.

### FORMULATION EXAMPLES

| Wettable powders | a) | b) | c) |
|---|---|---|---|
| Active ingredient | 25% | 50% | 75% |
| Sodium lignosulfonate | 5% | 5% | — |
| Sodium lauryl sulfate | 3% | — | 5% |
| Sodium diisobutylnaphthalenesulfonate | — | 6% | 10% |
| Phenol polyethylene glycol ether | — | 2% | — |
| (7-8 mol of ethylene oxide) | | | |
| Highly dispersed silicic acid | 5% | 10% | 10% |
| Kaolin | 62% | 27% | — |

The active ingredient is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| Active ingredient | 25% | 50% | 75% |
| Light mineral oil | 5% | 5% | 5% |
| Highly dispersed silicic acid | 5% | 5% | — |
| Kaolin | 65% | 40% | — |
| Talcum | — | | 20 |

The active ingredient is thoroughly mixed with the adjuvants and the mixture is thoroughly ground in a suitable mill, affording powders that can be used directly for seed treatment.

| Emulsifiable concentrate | |
|---|---|
| Active ingredient | 10% |
| Octylphenol polyethylene glycol ether | 3% |
| (4-5 mol of ethylene oxide) | |
| Calcium dodecylbenzenesulfonate | 3% |
| Castor oil polyglycol ether (35 mol of ethylene oxide) | 4% |
| Cyclohexanone | 30% |
| Xylene mixture | 50% |

Emulsions of any required dilution, which can be used in plant protection, can be obtained from this concentrate by dilution with water.

| Dusts | a) | b) | c) |
|---|---|---|---|
| Active ingredient | 5% | 6% | 4% |
| Talcum | 95% | — | — |
| Kaolin | — | 94% | — |
| Mineral filler | — | — | 96% |

Ready-for-use dusts are obtained by mixing the active ingredient with the carrier and grinding the mixture in a suitable mill. Such powders can also be used for dry dressings for seed.

| Extruded granules | |
|---|---|
| Active ingredient | 15% |
| Sodium lignosulfonate | 2% |
| Carboxymethylcellulose | 1% |
| Kaolin | 82% |

The active ingredient is mixed and ground with the adjuvants, and the mixture is moistened with water. The mixture is extruded and then dried in a stream of air.

| Coated granules | |
|---|---|
| Active ingredient | 8% |
| Polyethylene glycol (mol. wt. 200) | 3% |
| Kaolin | 89% |

The finely ground active ingredient is uniformly applied, in a mixer, to the kaolin moistened with polyethylene glycol. Non-dusty coated granules are obtained in this manner.

Suspension concentrate

| | |
|---|---|
| Active ingredient | 40% |
| Propylene glycol | 10% |
| Nonylphenol polyethylene glycol ether (15 mol of ethylene oxide) | 6% |
| Sodium lignosulfonate | 10% |
| Carboxymethylcellulose | 1% |
| Silicone oil (in the form of a 75% emulsion in water) | 1% |
| Water | 32% |

The finely ground active ingredient is mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Flowable concentrate for seed treatment

| | |
|---|---|
| Active ingredient | 40% |
| Propylene glycol | 5% |
| Copolymer butanol PO/EO | 2% |
| Tristyrenephenole with 10-20 moles EO | 2% |
| 1,2-benzisothiazolin-3-one (in the form of a 20% solution | 0.5% |
| in water) | |
| Monoazo-pigment calcium salt | 5% |
| Silicone oil (in the form of a 75% emulsion in water) | 0.2% |
| Water | 45.3% |

The finely ground active ingredient is mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Controlled Release Capsule Suspension

28 parts of a compound of formula I are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed.

The obtained capsule suspension is stabilized by adding 0.25 parts of a thickener and 3 parts of a dispersing agent. The capsule suspension formulation contains 28% of the active ingredients. The medium capsule diameter is 8-15 microns.

The resulting formulation is applied to seeds as an aqueous suspension in an apparatus suitable for that purpose.

### BIOLOGICAL EXAMPLES

### EXAMPLE B-1

### Treatment of turfgrass (Creeping Bentgrass) infected with Sclerotinia homoeocarpa

The following EC formulations were prepared:

| Component (in % w/v) | A | B |
|---|---|---|
| Compound of formula IAc (syn/anti ratio = 9:1) | 10.0 | 0 |
| Penthiopyrad * | 0 | 10.0 |
| Ethyl lactate | 20.0 | 20.0 |
| Castor oil/polyoxyethylene-copolymer | 6.0 | 6.0 |
| Calcium dodecylbenzenesulfonate | 4.0 | 4.0 |
| Tristyrenephenole/polyoxyethylene-copolymer | 2.0 | 2.0 |
| Methyl-phenylketone | 58.0 | 58.0 |

* known from JP-2004-123587

Plots were inoculated with Creeping Bentgrass (Agrostis palustris Huds.) seeds infested with Sclerotinia homoeocarpa, and a quantity of formulations A and B which corresponds to a dose shown in the table below and expressed in g/ha was sprayed on the plots. This treatment was repeated three times at an interval of 1 treatment every 14 days. 19 days after the last treatment, the disease incidence and severity was assessed visually. In the untreated Creeping Bentgrass 60% of the Creeping Bentgrass showed disease symptoms. Disease control is shown as % disease control compared to untreated Creeping Bentgrass.

TABLE B-1
Control of Sclerotinia homoeocarpa on Creeping Bentgrass

| | | % Disease |
|---|---|---|
| Product | Rate g ai/ha | Control |
| Formulation A—Compound IAc | 250 | 68% |
| Formulation A—Compound IAc | 350 | 82% |
| Formulation A—Compound IAc | 500 | 93% |
| Formulation B—Penthiopyrad | 250 | 48% |
| Formulation B—Penthiopyrad | 350 | 52% |
| Formulation B—Penthiopyrad | 500 | 57% |

The results in Table B-1 show that, at application rates of 250-500 g ai/ha, compound IAc is able to control Sclerotinia homoeocarpa on Creeping Bentgrass better than Penthiopyrad.

For example, Penthiopyrad used at a rate of 500 g/ha is able to control Sclerotinia homoeocarpa on Creeping Bentgrass at a level of 57%. In contrast, compound IAc is able to control this disease at a level of 93%.

### EXAMPLE B-2

### Treatment of turfgrass (Kentucky Bluegrass) infected with Sclerotinia homoeocarpa

Plots were inoculated with Kentucky Bluegrass (Poa pratensis L.) seeds infested with Sclerotinia homoeocarpa, and a quantity of formulations A and B which corresponds to a dose shown in the table below and expressed in g/ha was sprayed on the plots. This treatment was repeated three times at an interval of 1 treatment every 14 days. 19 days after the last treatment, the disease incidence and severity was assessed visually. In the untreated Kentucky Bluegrass 58% of the Kentucky Bluegrass showed disease symptoms. Disease control is shown as % disease control compared to untreated Kentucky Bluegrass.

TABLE B-2
Control of Sclerotinia homoeocarpa on Kentucky Bluegrass

| | | % Disease |
|---|---|---|
| Product | Rate g ai/ha | Control |
| Formulation A—Compound IAc | 250 | 62% |
| Formulation A—Compound IAc | 350 | 62% |
| Formulation A—Compound IAc | 500 | 88% |
| Formulation B—Penthiopyrad | 250 | 52% |
| Formulation B—Penthiopyrad | 350 | 24% |
| Formulation B—Penthiopyrad | 500 | 21% |

The results in Table B-2 show that, at application rates of 250-500 g ai/ha, compound IAc is able to control Sclerotinia homoeocarpa on Creeping Bentgrass better than Penthiopyrad. For example, Penthiopyrad used at a rate of 500 g/ha is able to control Sclerotinia homoeocarpa on Creeping Bentgrass at a level of 21%. In contrast, compound IAc is able to control this disease at a level of 88%.

### EXAMPLE B-3

### Treatment of Turfgrass (Annual Bluegrass/Creeping Bentgrass) Infected with Colletotrichum graminicola

The following EC formulation was prepared:

| Component (% w/w) | C |
|---|---|
| Compound of formula IAc (syn/anti ratio = 9:1) | 12.5 |
| Castor oil/polyoxyethylene-copolymer | 3.3 |
| Calcium dodecylbenzenesulfonate | 5.0 |
| Tristyrenephenole/polyoxyethylene-copolymer | 1.7 |
| Dipropylene glycol dibenzoate | 24 |
| Benzyl benzoate | 24 |
| Acetophenone | 29.5 |

Plots of a mixture of Annual Bluegrass (Poa annua) and Creeping Bentgrass (Agrostis stolifera) naturally infected with anthracnose (Colletotrichum graminicola) were treated with quantities of formulation C which correspond to a dose shown in the table below and expressed in g ai/ha. The dose corresponding to 250 g ai/ha was sprayed four times with an interval of 14 days. The dose corresponding to 500 g ai/ha was sprayed three times with an interval of 21 days. At 23 days after the final application with the 250 g ai/ha dose, and 10 days after the final application with the 500 g ai/ha dose, disease severity was assessed visually. In the untreated mixtures of Annual Bluegrass/Creeping Bentgrass 44% of the turf area showed disease symptoms. Disease control is shown as % disease control compared to untreated plots.

TABLE B-3
Control of Colletotrichum graminicola on Poa/Bentgrass

| | Rate | Application | % Disease |
|---|---|---|---|
| Product | g ai/ha | interval (days) | Control |
| Formulation C—Compound IAc | 250 | 14 | 56 |
| Formulation C—Compound IAc | 500 | 21 | 92 |
| Daconil Weather Stik ® | 7330 | 14 | 81 |

The results in Table B-3 show that at an application rate of 500 g ai/ha, compound IAc is able to control Colletotrichum graminicola on mixtures of Annual Bluegrass/Creeping Bentgrass better than Daconil Weather Stik®. For example, Daconil Weather Stik® at 7330 g ai/ha and with an application interval of 14 days is able to control Colletotrichum graminicola at a level of 81%. In contrast, compound IAc at 500 g ai/ha and with an application interval of 21 days is able to control this disease at a level of 92%.

### EXAMPLE B-4

### Treatment of Turfgrass (Colonial Bentgrass) infected with Rhizoctonia solani

Plots of Colonial Bentgrass (Agrostis tenius Sibth.) naturally infected with brown patch (Rhizoctonia solani) were treated with quantities of formulation C which correspond to a dose shown in the table below and expressed in g ai/ha. The dose corresponding to 302 g ai/ha was sprayed three times with an interval of 14 days. The dose corresponding to 604 g ai/ha was sprayed two times with an interval of 28 days. At 21 days after the final application of both dose rates, disease severity was assessed visually. In the untreated Colonial Bentgrass 80% of the turf area showed disease symptoms. Disease control is shown as % disease control compared to untreated plots.

TABLE B-4
Control of Rhizoctonia solani on Colonial Bentgrass

| | Rate | Application | % Disease |
|---|---|---|---|
| Product | g ai/ha | interval (days) | Control |
| Formulation C—Compound IAc | 302 | 14 | 97 |
| Formulation C—Compound IAc | 604 | 28 | 99 |
| Daconil Weather Stik ® | 8238 | 14 | 71 |

The results in Table B-4 show that at an application rate of 304 g ai/ha, compound 1Ac is able to control Rhizoctonia solani on Colonial Bentgrass better than Daconil Weather Stik®. For example, Daconil Weather Stik® at 8238 g ai/ha and with an application interval of 14 days is able to control Rhizoctonia solani at a level of 71%. In contrast, compound 1Ac at 302 g ai/ha and with an application interval of 14 days is able to control the disease at a level of 97%.

A further aspect of the instant invention is a method of protecting natural substances of plant and/or animal origin, which have been taken from the natural life cycle, and/or their processed forms against attack of fungi, which comprises applying to said natural substances of plant and/or animal origin or their processed forms a composition, that, in addition to formulation adjuvants, comprises a fungicidally effective amount of at least one compound of formula I

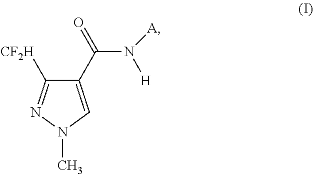

wherein A is

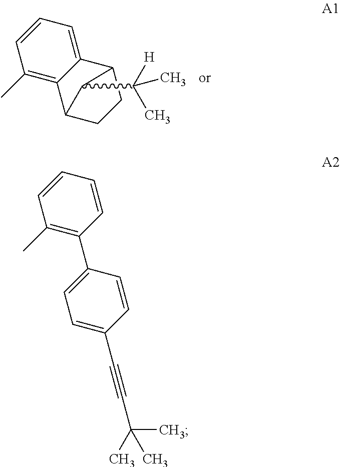

or a tautomer of such a compound.

According to the instant invention, the term “natural substances of plant origin, which have been taken from the natural life cycle” denotes plants or parts thereof which have been harvested from the natural life cycle and which are in the freshly harvested form. Examples of such natural substances of plant origin are stalks, leafs, tubers, seeds, fruits or grains. According to the instant invention, the term “processed form of a natural substance of plant origin” is understood to denote a form of a natural substance of plant origin that is the result of a modification process. Such modification processes can be used to transform the natural substance of plant origin in a more storable form of such a substance (a storage good). Examples of such modification processes are pre-drying, moistening, crushing, comminuting, grounding, compressing or roasting. Also falling under the definition of a processed form of a natural substance of plant origin is timber, whether in the form of crude timber, such as construction timber, electricity pylons and barriers, or in the form of finished articles, such as furniture or objects made from wood.

According to the instant invention, the term “natural substances of animal origin, which have been taken from the natural life cycle and/or their processed forms” is understood to denote material of animal origin such as skin, hides, leather, furs, hairs and the like.

The combinations according the present invention can prevent disadvantageous effects such as decay, discoloration or mold.

A preferred embodiment is a method of protecting natural substances of plant origin, which have been taken from the natural life cycle, and/or their processed forms against attack of fungi, which comprises applying to said natural substances of plant and/or animal origin or their processed forms a composition, that, in addition to formulation adjuvants, comprises a fungicidally effective amount of at least one compound of formula I.

A further preferred embodiment is a method of protecting fruits, preferably pomes, stone fruits, soft fruits and citrus fruits, which have been taken from the natural life cycle, and/or their processed forms, which comprises applying to said fruits and/or their processed forms a composition, that, in addition to formulation adjuvants, comprises a fungicidally effective amount of at least one compound of formula I.

In a preferred embodiment of this aspect of the present invention, compositions according to the invention comprise a compound of formula IA

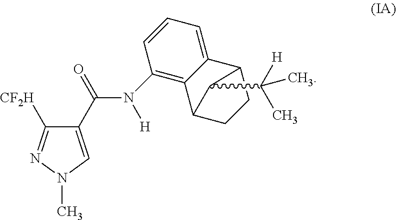

In a further preferred embodiment of this aspect of the present invention, compositions according to the invention comprise a compound of formula IB

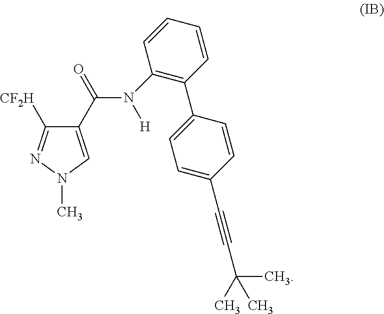

In a further preferred embodiment of this aspect of the present invention, the composition according to the invention comprises an active ingredient, which consists essentially of a fungicidally effective amount of a compound of formula I.

In a yet further preferred embodiment of this aspect of the present invention, the composition according to the invention comprises an active ingredient, which consists of a fungicidally effective amount of a compound of formula I.

The compositions according to the present invention may also be used in the field of protecting building materials against attack by fungi.

In a further aspect of the invention there is provided a method for the prevention and/or treatment of growth and/or infestation of a fungus on a building material comprising treating said material with a composition which comprises an active ingredient wherein said active ingredient consists essentially of a fungicidally effective amount of a compound of formula I

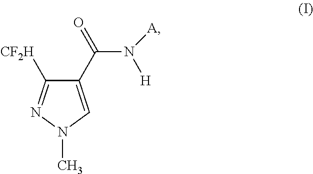

wherein A is

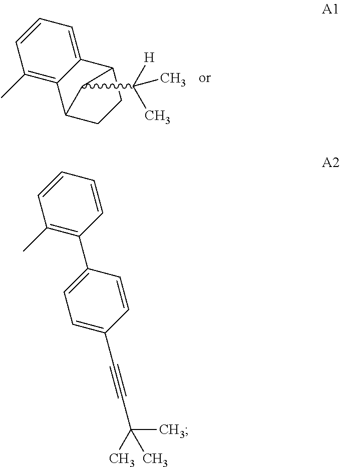

or a tautomer of such a compound.

In a particular embodiment of the present invention the composition according to the invention comprises an active ingredient wherein said active ingredient consists essentially of a compound of formula IA

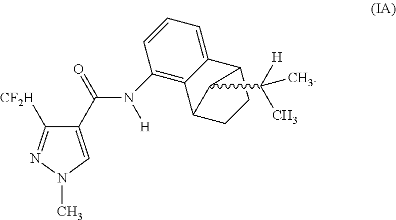

In a further embodiment of the present invention the composition according to the invention comprises an active ingredient wherein said active ingredient consists essentially of a compound of formula IB

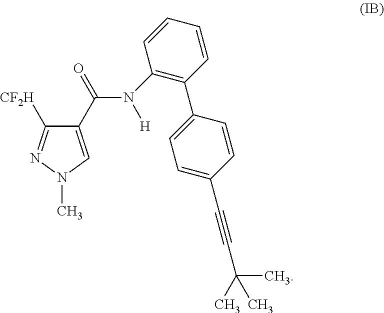

In a still further aspect of the invention there is provided the use of a composition as described above in a method of controlling fungal growth on a building material.

“Building material” means those materials used for construction and the like. In particular, building material includes wallboards, structural timber, doors, cupboards, storage units, carpets, particularly natural fibre carpets such as wool and hessian, soft furniture, wall or ceiling papers, and other surfaces such as painted walls, floors or ceilings, paints, plastics, wood (including engineered wood) and wood plastic composite. In addition to this, building material includes adhesives, sealants, joining materials and joints and insulation material. In a particular embodiment building materials means wallboards. In a further embodiment building materials means structural timber. In a further embodiment building materials means engineered wood. In a further embodiment building materials means plastic. Plastics includes plastic polymers and copolymers, including: acrylonitrile butadiene styrene, butyl rubber, epoxies, fluoropolymers, isoprene, nylons, polyethylene, polyurethane, polypropylene, polyvinyl chloride, polystyrene, polycarbonate, polyvinylidene fluoride, polyacrylate, polymethyl methacrylate, polyurethane, polybutylene, polybutylene terephthalate, polyether sulfone, polyphenyllenoxide, polyphenylene ether, polyphenylene sulfide, polyphtatamide, polysulphene, polyester, silicone, styrene butadiene rubber and combinations of polymers. In a further embodiment building material means polyvinyl chloride (PVC). In a further embodiment building material means polyurethane (PU). In a further embodiment building materials means paint. In a further embodiment building material means wood plastic composite (WPC). Wood plastic composite is a material that is well known in the art. A review of WPCs can be found in the following publication—Craig Clemons—Forrest Products Journal. June 2002 Vol 52. No. 6. pp 10-18.

“Wood” is to be understood as meaning wood and wood products, for example: derived timber products, lumber, plywood, chipboard, flakeboard, laminated beams, oriented strandboard, hardboard, and particleboard; paper food wrap, tropical wood, structural timber, wooden beams, railway sleepers, components of bridges, jetties, vehicles made of wood, boxes, pallets, containers, telegraph-poles, wooden fences, wooden lagging, windows and doors made of wood, plywood, chipboard, joinery, or wooden products which are used, quite generally, for building houses or decks, in building joinery or wood products that are generally used in house-building including engineered wood, construction and carpentry.

The methods of the invention can be used in the prevention and/or treatment of the growth/infestation by/of a fungus as described within this specification. The fungus can be controlled by treating the fungus or the building material with a fungicide according to the invention in a convenient manner. Examples of ways in which the fungus or building material can be treated with a fungicide according to the invention are: by including said fungicide in the building material itself, absorbing, impregnating, treating (in closed pressure or vacuum systems) said material with said fungicide, dipping or soaking the building material, or coating the building material for example by curtain coating, roller, brush, spray, atomisation, dusting, scattering or pouring application.

In a still further aspect of the invention there is provided a method for producing a treated building material comprising applying a fungicidally effective amount of the fungicide according to the invention to said material such that fungal contamination of said material is prevented and/or retarded.

In a still further aspect of the invention there is provided a method for re-treating a treated building material comprising applying to said material a fungicidally effective amount of the fungicide according to the invention such that fungal contamination of said material is prevented and/or retarded.

The present invention still further provides a building material obtainable by a method as described above.

In a still further aspect of the invention there is provided a building material treated with a fungicidally effective amount of a fungicide according to the invention such that growth of fungi on said material is prevented.

The present invention still further provides a building comprising a building material as described above. In a particular embodiment said building is a temporary building. In a further embodiment said building is a permanent structure.

In a still further aspect of the invention there is provided the use of a fungicide according to the invention in a method of treating a building material to prevent and/or treat growth and/or infestation of a fungus as described above on said material.

Examples of problematic fungi are: Alternaria alternata, Alternaria tenuissima, Aureobasidium pullulans, Aspergillus flavus, Aspergillus niger, Aspergillus terreus, Aspergillus fumigatus, Aspergillus repens, Aspergillus versicolor, Candida albicans, Cladosporium cladosporioides, Cladosporium herbarum, Cladosporium sphaerospermum, Coniophora puteana, Curvularia genticulata, Diplodia natalensis, Epidermophyton floccosum, Fusarium oxysporum, Gliocladium virens, Gloeophyllum trabeum Humicola grisea, Lecythophora mutabilis, Lentinus cyathiformis, Lentinus lepidus, Memnionella echinata, Mucor indicus, Mucor racemosus, Oligoporus placenta, Paecilomyces variotii, Penicillium citrinum, Penicillium funiculosum, Penicillium ochrochloron, Penicillium purpurogenum, Penicillium pinophilum, Penicillium variabile, Petriella setifera, Phanerochaete chrysosporium, Phoma violacea, Poria placenta, Rhodotorula rubra, Schizophyllum commune, Sclerophoma phytiophila Scopulariopsis brevicaulis, Serpula lacrymans, Sporobolomyces roseus, Stachybotrys atra, Stachybotrys chartarum, Stemphylium dendriticum, Trichophyton mentagrophytes, Trichurus spiralis, Trichophyton rubrum, Ulocladium atrum and Ulocladium chartarum.

Of particular concern are: Alternaria alternata, Alternaria tenuissima, Aspergillus niger, Aspergillus versicolor, Aureobasidium pullulans, Cladosporium cladosporioides, Coniophora puteana, Gloeophyllum trabeum, Memnionella echinata, Mucor indicus, Oligoporus placenta, Penicillium citrinum, Penicillium funiculosum, Penicillium pinophilum, Sclerophoma phytiophila, Stachybotrys atra, Stachybotrys chartarum, and Ulocladium chartarum.

The combinations according to the present invention are particularly effective against post harvest diseasese such as Botrytis cinerea, Colletotrichum musae, Curvularia lunata, Fusarium semitecum, Geotrichum candidum, Monilinia fructicola, Monilinia fructigena, Monilinia laxa, Mucor piriformis, Penicilium italicum, Penicilium solitum, Penicillium digitatum or Penicillium expansum in particular against pathogens of fruits, such as pomefruits, for example apples and pears, stone fruits, for example peaches and plums, citrus, melons, papaya, kiwi, mango, berries, for example strawberries, avocados, pomegranates and bananas, and nuts.

The amount of a combination of the invention to be applied, will depend on various factors, such as the compounds employed; the subject of the treatment, such as, for example natural substances of plant and/or animal origin, which have been taken from the natural life cycle, and/or their processed forms; Building materials; the type of treatment, such as, for example spraying, dusting or spreading or the type of fungi to be controlled.

The compositions according to the invention are applied by treating the fungi, the natural substances of plant and/or animal origin, which have been taken from the natural life cycle, and/or their processed forms, or the Building materials threatened by fungus attack with a composition according to the invention.

The compositions according to the invention may be applied before or after infection of the the propagation material thereof, the natural substances of plant and/or animal origin, which have been taken from the natural life cycle, and/or their processed forms, or the Building materials by the fungi.

What is claimed is:

1. A method of controlling phytopathogenic diseases on turfgrass or on seeds thereof, which comprises applying to the turfgrass, the locus thereof or seeds thereof a composition, that, in addition to formulation adjuvants, comprises a fungicidally effective amount of at least one compound of formula I 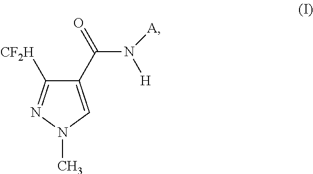
wherein A is 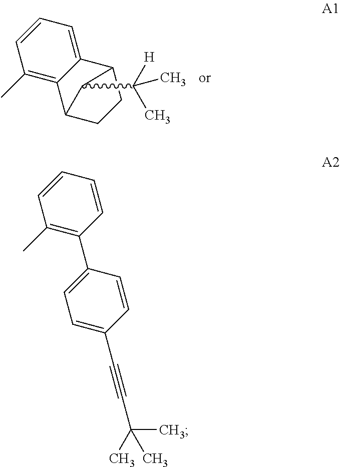
or a tautomer of such a compound.

2. The method according to claim 1, wherein the compound of formula I is a compound of formula IA

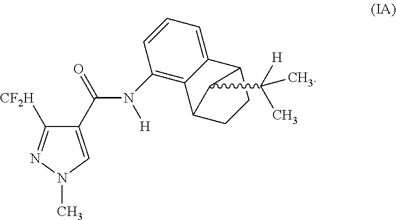

3. The method according to claim 1, wherein the compound of formula I is a compound of formula IB

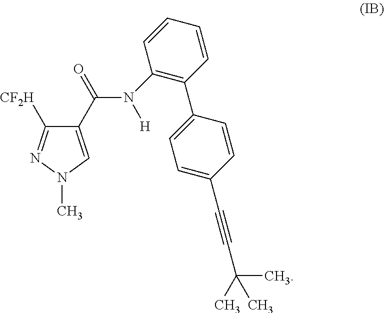

4. The method according to claim 1, wherein the composition comprises from 0.01 to 90% by weight of the compound of formula I, from 10 to 99.99% of a carrier and from 0 to 20% of a surfactant.

5. The method of controlling phytopathogenic diseases on turfgrass according to claim 1, wherein the composition is applied to the turfgrass or to the locus thereof.

6. The method according to claim 5, wherein the composition is applied to the turfgrass.

7. The method according to claim 6, wherein the compound of formula I is applied in an amount between 10 and 2000 g/ha.

8. The method according to claim 6, wherein the compound of formula I is applied in an amount between 200 and 800 g/ha.

9. The method according to claim 5, wherein the composition is applied to the locus of the turfgrass.

10. The method of controlling phytopathogenic diseases on turfgrass or on seeds thereof according to claim 1, wherein the composition is applied to the seeds thereof.

11. The method according to claim 1, wherein the phytopathogenic disease is caused by one or more phytopathogenic fungi selected from the group consisting of Colletotrichum graminicola, Pythium spp., Rhizoctonia solani, Sclerotinia homeocarpa, Gaeumannomyces graminis, Microdochium nivale, Typhula incarnata, Pyricularia grisea Drechslera spp., Marielliottia spp., Bipolaris spp., Curvularia spp. and Exserohilum spp.

12. The method according to claim 1, wherein the phytopathogenic disease is caused by one or more phytopathogenic fungi selected from the group consisting of Colletotrichum graminicola, Rhizoctonia solani and Sclerotinia homeocarpa.

13. The method according to claim 1, wherein the phytopathogenic disease is caused by Sclerotinia homeocarpa.

14. The method according to claim 1, wherein the turfgrass is an annual or perennial Gramineae belonging to at least one of the genera Agropyron, Agrostis, Axonopus, Bromus, Buchloë, Cynodon, Eremochloa, Festuca, Lolium, Paspulum, Pennisetum, Phleum, Poa, Stenotaphrum or Zoysia.

15. A method of controlling phytopathogenic diseases on turfgrass or on seeds thereof, which comprises applying to the turfgrass, the locus thereof or seeds thereof a composition, that, in addition to formulation adjuvants, comprises an active ingredient, which consists essentially of a fungicidally effective amount of a compound of formula I according to claim 1 or a tautomer of such a compound.

16. A method to improve the quality of turfgrass, which comprises applying to the turfgrass, the locus thereof or seeds thereof a composition, that, in addition to formulation adjuvants, comprises an amount effective to increase turfgrass quality of a compound of formula I according to claim 1 or a tautomer of such a compound.
